(19) United States
(12) Patent Application Publication
(10) Pub. No.: US 2023/0039137 A1
(43) Pub. Date: Feb. 9, 2023

(54) FILM AND WATER STOPPING TAPE

(71) Applicant: FUJIFILM CORPORATION, Tokyo (JP)

(72) Inventors: Haruki TOMIKAWA, Kanagawa (JP); Toshihide YOSHITANI, Kanagawa (JP); Kyohisa UCHIUMI, Kanagawa (JP); Ren ISHIKAWA, Kanagawa (JP)

(21) Appl. No.: 17/815,934

(22) Filed: Jul. 28, 2022

(30) Foreign Application Priority Data
Jul. 30, 2021 (JP) 2021-126170

(51) Int. Cl. B01J 20/26; B01J 20/28; B32B 27/12

(52) U.S. Cl. CPC B01J 20/262; B01J 20/28038; B01J 20/28035; B32B 27/12; B32B 5/022

(57) ABSTRACT

Provided are a film and a water stopping tape that realize long-lasting water stopping properties. The film includes an outermost layer that contains a water-absorbent polymer and a fiber assembly and a substrate layer in this order, in which a degree of out-of-plane swelling of the outermost layer is higher than a degree of in-plane swelling of the outermost layer, and the water stopping tape includes the film.

### CROSS-REFERENCE TO RELATED APPLICATION

The present application claims priority under 35 U.S.C. § 119 to Japanese Patent Application No. 2021-126170, filed Jul. 30, 2021. The above application is hereby expressly incorporated by reference, in its entirety, into the present application.

### BACKGROUND OF THE INVENTION

### 1. Field of the Invention

The present disclosure relates to a film and a water stopping tape.

### 2. Description of the Related Art

Polymers having properties of absorbing water are used in various articles such as a waterproof sheet. As applications of polymers having properties of absorbing water, the following techniques are known.

For example, JP2009-084840A discloses a waterproof sheet for construction groundworks. In the waterproof sheet for construction groundworks, a nonwoven fabric having a swelling layer consisting of a water-absorbent polymer resin is interposed between two layers of synthetic resin films. In the swelling layer, a water-absorbent polymer resin that swells more than 200 times by absorbing water is used.

For example, JP2020-151605A discloses an absorber. In the absorber, an absorbent layer containing a super water-absorbent polymer and a spunbond nonwoven fabric composed of an olefin-based polymer composition is used.

For example, JP2005-113339A discloses a laminate. In the laminate, a nonwoven fabric layer that contains synthetic pulp, natural fibers, and a binder is used, in which fibrillar synthetic pulp in the form of fibers is in the nonwoven fabric. A nonwoven fabric layer further containing a super water-absorbent polymer is also used in the laminate.

For example, JP1986-028003A (JP-561-028003A) discloses an absorber in a sanitary article. In the absorber, a core layer composed of a nonwoven fabric and a powdery or fibrous super water-absorbent polymer bonded to the nonwoven fabric is used.

For example, JP2016-032455A discloses a greening sheet. In the greening sheet, a fabric having a water-absorbent resin sheet layer made of a thermoplastic polyurethane resin is used.

### SUMMARY OF THE INVENTION

As an application of polymers having properties of absorbing water, a water stopping technique is being studied. Examples of the water stopping technique include a technique of stopping water entering a building through gaps of objects such as windows and doors. The above water stopping technique is considered to be useful, for example, as a flood control measure.

In JP2009-084840A, water stopping properties for nail holes formed in a waterproof sheet for construction groundworks are emphasized. The water that has entered from around the nail holes formed in the waterproof sheet for construction groundworks is absorbed into the water-absorbent polymer resin of the swelling layer, the water-absorbent polymer resin swells to stop up microvoids around the nail holes and prevents permeation of water. Incidentally, the swelling layer is interposed between two layers of synthetic resin films. Therefore, the swollen water-absorbent polymer resin can stop up the water permeating holes in the waterproof sheet for construction groundworks, but cannot stop up water permeating holes in objects other than the waterproof sheet for construction groundworks.

Furthermore, even though the techniques disclosed in JP2020-151605A, JP2005-113339A, JP1986-028003A (JP-S61-028003A), and JP2016-032455A are used for the water stopping technique, there is the possibility that excellent water stopping properties may not be obtained, and duration of the water stopping properties may be shortened. For example, in a case where the polymer-containing layer expands by absorbing a large amount of water, the polymer-containing layer may peel off due to the increase in strain. Furthermore, the polymer is likely to leak from the swollen polymer-containing layer. These phenomena are likely to lead to shortening of the duration of water stopping properties.

An embodiment of the present disclosure aims to provide a film that realizes long-lasting water stopping properties. Another embodiment of the present disclosure aims to provide a water stopping tape that realizes long-lasting water stopping properties.

The present disclosure includes the following aspects.

<1> A film including an outermost layer that contains a water-absorbent polymer and a fiber assembly and a substrate layer in this order, in which a degree of out-of-plane swelling of the outermost layer is higher than a degree of in-plane swelling of the outermost layer.

<2> The film described in <1>, in which the degree of in-plane swelling of the outermost layer is isotropic.

<3> The film described in <1> or <2>, in which the water-absorbent polymer coats fibers of the fiber assembly.

<4> The film described in any one of <1> to <3>, in which the outermost layer contains a plasticizer.

<5> The film described in any one of <1> to <4>, in which the water-absorbent polymer includes a polyurethane.

<6> A water stopping tape containing the film described in any one of <1> to <5>.

According to an embodiment of the present disclosure, a film that realizes long-lasting water stopping properties is provided. According to another embodiment of the present disclosure, a water stopping tape that realizes long-lasting water stopping properties is provided.

### BRIEF DESCRIPTION OF THE DRAWINGS

FIG. 1 is a schematic plan view showing the configuration of a film according to an embodiment.

FIG. 2 is a cross-sectional view taken along the line A-A in FIG. 1.

FIG. 3 is a schematic cross-sectional view showing the configuration of a film according to another embodiment.

### DESCRIPTION OF THE PREFERRED EMBODIMENTS

Hereinafter, embodiments of the present disclosure will be specifically described. The present disclosure is not limited to the following embodiments. The following embodiments may be modified as appropriate within the intended scope of the present disclosure.

In a case where the embodiments of the present disclosure are described with reference to the drawings, sometimes the constituents and reference numerals overlapping in the drawings are not described. The constituents represented by the same reference numeral in the drawings are the same constituents. The dimensional ratio in the drawings does not necessarily represent the actual dimensional ratio. For convenience, sometimes a certain constituent is highlighted in the drawings.

In the present disclosure, a range of numerical values described using “to” means a range including the numerical values listed before and after “to” as the lower limit and the upper limit.

As for numerical ranges described stepwise in the present disclosure, the upper limit of a certain numerical range may be replaced with the upper limit of another numerical range described stepwise, and the lower limit of a certain numerical range may be replaced with the lower limit of another numerical range described stepwise. In addition, as for the numerical described stepwise in the present disclosure, the upper or lower limit of a certain numerical range may be replaced with the values described in examples.

In the present disclosure, in a case where there is a plurality of substances in a composition that corresponds to each component of the composition, unless otherwise specified, the amount of each component of the composition means the total amount of the plurality of substances present in the composition.

In the present disclosure, a combination of preferable aspects is a more preferable aspect.

Film

Hereinafter, the film according to an aspect of the present disclosure will be described.

In an embodiment of the present disclosure, the film includes an outermost layer that contains a water-absorbent polymer and a fiber assembly and a substrate layer in this order. Furthermore, a degree of out-of-plane swelling of the outermost layer is higher than a degree of in-plane swelling of the outermost layer. In the present disclosure, “water-absorbent polymer” means a polymer having a water absorbency of 5 g/g or more. Details of the water absorbency will be described in the following section of “Outermost layer”. In the present disclosure, “out-of-plane” means a direction parallel to the thickness direction of an object. In the present disclosure, “in-plane” means a direction orthogonal to the thickness direction of an object.

According to the embodiment described above, a film that realizes long-lasting water stopping properties is provided. Presumably, duration of the water stopping properties may increase for the following reason. For example, in a case where a film is used as a method of preventing or reducing permeation of water into an object to protect such as a building, the film is disposed on a water permeating hole (for example, a gap) so that the outermost layer faces the water permeating hole. In a case where the outermost layer expands due to the absorption of water, the expanded outermost layer stops up the water permeating hole, which makes it possible to prevent or reduce the entering of water. In a case where the degree of out-of-plane swelling of the outermost layer is higher than the degree of in-plane swelling of the outermost layer, the strain resulting from in-plane swelling of the outermost layer is reduced. As a result, for example, peeling of the swollen outermost layer is prevented. Therefore, a film that realizes long-lasting water stopping properties is provided.

Outermost Layer

In an embodiment of the present disclosure, the film includes an outermost layer. The outermost layer is located on the outermost side in the laminated structure of the film. For example, in a case where the film is used in a water permeation preventing or reducing method as a water stopping technique, the outermost layer can be placed to face a water permeating hole, and the outermost layer expanding by absorption of water can prevent or mitigate permeation of water by stopping up the water permeating hole.

The degree of out-of-plane swelling of the outermost layer is higher than the degree of in-plane swelling of the outermost layer. In a case where the degree of out-of-plane swelling of the outermost layer is higher than the degree of in-plane swelling of the outermost layer, the water stopping properties last for a long time. From the viewpoint of long-lasting water stopping properties, the ratio of the degree of out-of-plane swelling of the outermost layer to the degree of in-plane swelling of the outermost layer is preferably 2.0 or more, more preferably 4.0 or more, and even more preferably 6.0 or more. In addition, the ratio of the degree of out-of-plane swelling of the outermost layer to the degree of in-plane swelling of the outermost layer is preferably 8.0 or more, more preferably 10.0 or more, and even more preferably 12.0 or more. From the viewpoint of preventing the film used by being attached to an object from being peeled off, the ratio of the degree of out-of-plane swelling of the outermost layer to the degree of in-plane swelling of the outermost layer is preferably 100.0 or less, more preferably 50.0 or less, and even more preferably 15.0 or less. Examples of factors affecting the degree of swelling of the outermost layer include the water absorbency of the water-absorbent polymer, the arrangement of fibers of the fiber assembly, and how tightly the fibers of the fiber assembly are bound together. For example, in a case where fibers that readily expand and contract in the in-plane direction are used, swelling of the outermost layer in the out-of-plane direction of the outermost layer is further suppressed than swelling of the outermost layer in the in-plane direction of the outermost layer.

The degree of out-of-plane swelling of the outermost layer and the degree of in-plane swelling of the outermost layer are measured by the following method.

(1) The outermost layer is peeled off from the film, and then cut into a circle having a diameter of 100 mm.

(2) The outermost layer is immersed in pure water at 25° C.

(3) After being immersed for 5 hours, the outermost layer is taken out of the pure water.

(4) The ratio of the maximum diameter of the outermost layer having been immersed to the maximum diameter (that is, 100 mm) of the outermost layer not yet being immersed is calculated, and the obtained value is adopted as “degree of in-plane swelling of the outermost layer”.

(5) The ratio of the maximum thickness of the outermost layer having been immersed to the maximum thickness of the outermost layer not yet being immersed is calculated, and the obtained value is adopted as “degree of out-of-plane swelling of the outermost layer”. For measuring the thickness of the outermost layer, the outermost layer is placed on a stainless steel plate, the thickness of the laminate including the stainless steel plate and the outermost layer is then measured using a stylus-type film thickness meter, and then the thickness of the stainless steel plate is subtracted from the thickness of the laminate including the stainless steel plate and the outermost layer so that the thickness of the outermost layer is determined.

From the viewpoint of long-lasting water stopping properties, the degree of in-plane swelling of the outermost layer is preferably isotropic. Whether or not the degree of in-plane swelling of the outermost layer is isotropic is confirmed by the following method.

(1) The outermost layer is peeled off from the film, and then cut into a circle having a diameter of 100 mm.

(2) The outermost layer is immersed in pure water at 25° C.

(3) After being immersed for 5 hours, the outermost layer is taken out of the pure water.

(4) The diameter of the outermost layer having been immersed is measured in each of the two directions orthogonal to each other.

(5) In a case where the ratio of the diameter measured in one of the two directions to the diameter measured in the other direction is in a range of 0.9 to 1.1, the degree of in-plane swelling of the outermost layer is considered to be isotropic.

The outermost layer contains a water-absorbent polymer, that is, a polymer having a water absorbency of 5 g/g or more. In the present disclosure, “water absorbency” is represented by the ratio of a mass of a sample having been immersed in water for 3 hours to a mass of the sample not yet being immersed in water. The water absorbency is measured by a water immersion test. The specific procedure of the water immersion test is described below.

(1) A mixture obtained by adding 0.1 g of a sample to 200 mL of pure water is stirred. The temperature of the pure water is 25° C.

(2) After 3 hours of stirring, the mixture is filtered through a wire mesh having an opening size of 75 μm (for example, a mesh sieve manufactured by TOKYO SCREEN CO., LTD). Here, in a case where the sample (excluding the sample dissolved in pure water) passes through the wire mesh, a wire mesh having an opening size smaller than 75 μm may be used.

(3) Three minutes after the end of filtration, the mass (unit: g) of the sample remaining on the wire mesh is measured, and the obtained value is adopted as “mass of a sample having been immersed in water for 3 hours”.

(4) The ratio of the mass of a sample having been immersed in water for 3 hours to the mass (that is, 0.1 g) of the sample not yet being immersed in water is calculated, and the obtained value is adopted as “water absorbency”.

From the viewpoint of improving water stopping properties, the water absorbency of the water-absorbent polymer is preferably 10 g/g or more, more preferably 15 g/g or more, and even more preferably 20 g/g or more. From the viewpoint of preventing peeling resulting from overexpansion, the water absorbency of the water-absorbent polymer is preferably 100 g/g or less, more preferably 70 g/g or less, and even more preferably 40 g/g or less. The water absorbency may be adjusted by a known method. The water absorbency is adjusted, for example, by a chemical structure and a molecular weight. For example, in a case where the polyurethane obtained using a polyalkylene oxide is used as the water-absorbent polymer, increasing the proportion of the polyalkylene oxide (preferably at least one kind of compound selected from the group consisting of polyethylene oxide and polypropylene oxide) enhances the water absorbency. For example, increasing the ratio of polyethylene oxide to polypropylene oxide enhances the water absorbency. For instance, in a case where the polyurethane obtained using a diol is used as the water-absorbent polymer, increasing the proportion of the diol enhances the water absorbency.

As long as the water absorbency is 5 g/g to 100 g/g, the type of water-absorbent polymer is not limited. From the viewpoint of improving water stopping properties and degree of freedom of structure design, the water-absorbent polymer preferably includes a polyurethane. The structure of polyurethane can be designed with a high degree of freedom, and the water absorbency can be freely adjusted depending on the structure design. In addition, the film containing a polyurethane as the water-absorbent polymer can exhibit high water stopping properties even to water having a high salt concentration such as sea water. Because most polyurethanes are soluble in a solvent and have thermoplasticity, the environmental load in the manufacturing process could be reduced.

From the viewpoint of improving water stopping properties and a degree of freedom of structure design, the polyurethane preferably includes a hard segment and a soft segment. The hard segment is a region that is relatively harder than the soft segment. The hard segment is formed, for example, by the reaction between a short-chain polyol (for example, a low-molecular-weight diol) and an isocyanate. Because the soft segment can carry water, increasing the proportion of the soft segment leads to the increase of water absorbency. The soft segment is formed, for example, by the reaction between a long-chain polyol (for example, polyalkylene oxide) and an isocyanate.

The polyurethane may be selected from known polyurethanes having a water absorbency of 5 g/g or more. Examples of the polyurethane include polyurethane obtained by reacting an active hydrogen-containing compound with an isocyanate. Examples of preferable polyurethanes include a polyurethane obtained by reacting a polyalkylene oxide, a diol having a molecular weight of 500 or less, and a diisocyanate. The polyalkylene oxide and the diisocyanate contribute to the formation of the soft segment. The diol having a molecular weight of 500 or less and the diisocyanate contribute to the formation of the hard segment.

Examples of the active hydrogen-containing compound include a compound having a hydroxy group. Examples of the compound having a hydroxy group include a polyalkylene oxide and a low-molecular-weight diol. One kind of active hydrogen-containing compound or two or more kinds of active hydrogen-containing compounds may be used.

Examples of the polyalkylene oxide include polyethylene oxide and polypropylene oxide. The polyalkylene oxide preferably includes polyethylene oxide. The polyalkylene oxide is preferably at least one kind of compound selected from the group consisting of polyethylene oxide and polypropylene oxide, and more preferably polyethylene oxide. One kind of polyalkylene oxide or two or more kinds of polyalkylene oxides may be used. The polyalkylene oxide may be polyethylene oxide or polypropylene oxide.

In a case where polyethylene oxide and polypropylene oxide are used together, the ratio of the total mass of the polypropylene oxide to the total mass of the polyethylene oxide (that is, [total mass of polypropylene oxide]/[total mass of polyethylene oxide]) is preferably 0.10 to 0.35, more preferably 0.15 to 0.30, and even more preferably 0.15 to 0.25.

The weight-average molecular weight of the polyalkylene oxide is preferably 3,000 to 100,000, more preferably 3,000 to 80,000, and even more preferably 3,000 to 60,000.

The weight-average molecular weight of the polyethylene oxide is preferably 10,000 to 100,000, more preferably 20,000 to 80,000, and even more preferably 30,000 to 60,000.

The weight-average molecular weight of the polypropylene oxide is preferably 3,000 to 50,000, more preferably 3,000 to 30,000, and even more preferably 3,000 to 10,000.

In the present disclosure, the weight-average molecular weight is measured by gel permeation chromatography (GPC). The measurement conditions of gel permeation chromatography (GPC) are as follows. The calibration curve is plotted from 8 samples of “Standard sample TSK standard, polystyrene” manufactured by Tosoh Corporation: “F-40”, “F-20”, “F-4”, “F-1”, “A-5000”, “A-2500”, “A-1000”, and “n-propylbenzene”.

Measuring device: HLC (registered trademark)-8020GPC (manufactured by Tosoh Corporation)

Column: TSKgel (registered trademark) Super Multipore HZ-H (4.6 mm ID×15 cm, manufactured by Tosoh Corporation)×3

Eluent: tetrahydrofuran (THF), N-methylpyrrolidone (NMP), dimethylformamide (DMF), or water

Sample concentration: 0.45% by mass

Flow rate: 0.35 mL/min

Amount of sample injected: 10 μL

Measurement temperature: 40° C.

Detector: RI detector

Examples of the low-molecular-weight diol include a diol having a molecular weight of 500 or less. The lower limit of the molecular weight of the diol may be 62. Examples of the low-molecular-weight diol include ethylene glycol, diethylene glycol, triethylene glycol, tetraethylene glycol, propylene glycol, dipropylene glycol, trimethylene glycol, 1,3-butanediol, 2,3-butanediol, 1,4-butanediol, 1,5-pentanediol, hexylene glycol, octylene glycol, glyceryl monoacetate, glyceryl monobutyrate, 1,6-hexanediol, and 1,9-nonanediol. The low-molecular-weight diol is preferably 1,4-butanediol. One kind of low-molecular-weight diol or two or more kinds of low-molecular-weight diols may be used.

Examples of the isocyanate include a diisocyanate. Examples of the diisocyanate include an aliphatic diisocyanate and an aromatic diisocyanate. Specific examples of the diisocyanate include 4,4′-diphenylmethane diisocyanate, 1,6-hexamethylene diisocyanate, 1,8-dimethylbenzol-2,4-diisocyanate, 2,4-tolylene diisocyanate, and 2,2′-dimethyl-4,4′-diphenylmethane diisocyanate, 1,3-bis(isocyanatemethyl)benzene, 1,4-bis(isocyanatemethyl)benzene, 1,3-bis(isocyanatemethyl)cyclohexane, 1,4-bis(isocyanatemethyl)cyclohexane, 4,4′-dicyclohexylmethane diisocyanate, and isophorone diisocyanate. The diisocyanate is preferably 4,4′-diphenylmethane diisocyanate. One kind of isocyanate or two or more kinds of isocyanates may be used.

The polyurethane may be a commercially available product. Examples of the commercially available product include a super water-absorbent thermoplastic polyurethane elastomer manufactured by BASF SE (trade name: ELASTOLLAN BO38) and hydrophilic polyurethane (trade names: AQUACALK C, AQUACALK TWB, and AQUACALK TWB-P) manufactured by SUMITOMO SEIKA CHEMICALS CO., LTD.

Examples of the water-absorbent polymer include a (meth)acrylic polymer, a vinyl-based polymer, and polysaccharides.

“(Meth)acrylic polymer” means a polymer containing a constitutional unit derived from a monomer having a (meth)acryloyl group. The term “(meth)acryloyl group” includes an acryloyl group or a methacryloyl group or includes both the acryloyl group and methacryloyl group.

The (meth)acrylic polymer may be a homopolymer or a copolymer.

Examples of the monomer having a (meth)acryloyl group include a (meth)acrylic acid, a (meth)acrylamide, and a (meth)acrylic acid ester.

Examples of the (meth)acrylamide include acrylamide, methacrylamide, N-methylacrylamide, N,N′-dimethylacrylamide, N,N′-dimethylmethacrylamide, and N-methylolacrylamide.

The (meth)acrylic acid ester is preferably a (meth)acrylic acid alkyl ester, and more preferably a (meth)acrylic acid alkyl ester having 1 to 4 carbon atoms in the alkyl moiety. Examples of the (meth)acrylic acid alkyl ester include methyl (meth)acrylate, ethyl (meth)acrylate, butyl (meth)acrylate, and isobutyl (meth)acrylate.

Examples of the (meth)acrylic polymer include a polyacrylic acid, a polymethacrylic acid, a polyacrylate, a crosslinked polyacrylic acid, a crosslinked polyacrylate, an acrylic acid/acrylate copolymer, a polyacrylamide, polymethacrylamide, an acrylamide/acrylic acid copolymer, an acrylamide/methacrylic acid copolymer, an acrylamide/methyl acrylate copolymer, an acrylamide/methyl methacrylate copolymer, a N,N′-di methylacrylamide/N-methylolacrylamide/methyl methacrylate copolymer, polymethyl (meth)acrylate, polyethyl (meth)acrylate, polybutyl (meth)acrylate, and polyisobutyl (meth)acrylate.

The weight-average molecular weight of the (meth)acrylic polymer is preferably 100,000 to 10,000,000, more preferably 250,000 to 5,000,000, and even more preferably 500,000 to 2,500,000. The weight-average molecular weight is measured by the method described above.

“Vinyl-based polymer” means a polymer containing a constitutional unit derived from a monomer having a vinyl group. The vinyl-based polymer may be a homopolymer or a copolymer.

Examples of the monomer having a vinyl group include vinyl acetate, vinylpyrrolidone, and vinyl methyl ether.

Examples of the vinyl-based polymer include polyvinyl alcohol, polyvinylpyrrolidone, polyvinylpolypyrrolidone, and polyvinyl methyl ether.

Examples of the polysaccharides include alginate, xanthan gum, gellan gum, gum tragacanth, karaya gum, gum arabic, carrageenan, dextrin, agar, pectin, pullulan, locust bean gum, sacran, tamarind seed gum, hydroxyethyl cellulose, hydroxypropyl cellulose, carboxymethyl cellulose, carboxymethyl ethyl cellulose, a hydroxypropyl cellulose salt, a carboxymethyl cellulose salt, a carboxymethyl ethyl cellulose salt, cellulose nanofibers (for example, Tempo-oxidized cellulose nanofibers, carboxymethylated cellulose nanofibers, phosphoesterified cellulose nanofibers, and mechanically defibrated cellulose nanofibers), chitosan nanofibers, cellulose microfibrils, hyaluronate, and hyaluronic acid.

It is preferable that the water-absorbent polymer contained in the outermost layer be crosslinked. The water-absorbent polymer crosslinked in advance may be used, or the water-absorbent polymer may be crosslinked in the process of forming the outermost layer.

The form of the water-absorbent polymer is not limited. The water-absorbent polymer may be particles.

The water-absorbent polymer may be unevenly distributed on the outermost layer, or may be evenly distributed on the outermost layer. The water-absorbent polymer is preferably uniformly distributed in the fiber assembly along the out-of-plane direction of the outermost layer.

The water-absorbent polymer may be in contact with the fibers of the fiber assembly. The water-absorbent polymer may partially permeate the fibers of the fiber assembly. It is preferable that the water-absorbent polymer be in contact with the fibers of the fiber assembly. It is preferable that the water-absorbent polymer coat the fibers of the fiber assembly. The water-absorbent polymer may coat some or all of the fibers of the fiber assembly. The state of the water-absorbent polymer within the outermost layer is checked by at least visual observation or microscopic observation on the cut surface.

The outermost layer may contain one kind of water-absorbent polymer or two or more kinds of water-absorbent polymers.

From the viewpoint of long-lasting water stopping properties, the ratio of the total mass of the water-absorbent polymer to the total mass of the outermost layer is preferably 10% by mass to 100% by mass, more preferably 30% by mass to 100% by mass, and even more preferably 50% by mass to 100% by mass. The ratio of the total mass of the water-absorbent polymer to the total mass of the outermost layer may be less than 100% by mass.

The outermost layer contains a fiber assembly. The fiber assembly regulates the swelling of the outermost layer in the in-plane direction, and contributes to the expression of characteristic that the degree of out-of-plane swelling of the outermost layer is higher than the degree of in-plane swelling of the outermost layer.

Examples of the fiber assembly include a nonwoven fabric, a fabric, and a knit. From the viewpoint of long-lasting water stopping properties, the fiber assembly is preferably a nonwoven fabric, a fabric, or a knit, and more preferably a nonwoven fabric. For example, the nonwoven fabric is expected to bring about an effect of maintaining strength of the swollen outermost layer. Furthermore, for example, the nonwoven fabric is expected to bring about an effect of suppressing leakage of the water-absorbent polymer (including the water-absorbent polymer having absorbed water) from the swollen outermost layer.

Examples of the fibers contained in the fiber assembly include cellulose fibers, rayon fibers, polyolefin fibers (for example, polyethylene fibers and polypropylene fibers), polyvinyl chloride fibers, polyester fibers, polyurethane fibers, and polyamide fibers. The fiber assembly preferably contains at least one kind of fibers selected from the group consisting of cellulose fibers, rayon fibers, polyolefin fibers, and polyester fibers, and more preferably contains at least one kind of fibers selected from the group consisting of rayon fibers, polyolefin fibers, and polyester fibers. The fiber assembly may contain rayon fibers, polyolefin fibers, and polyester fibers.

The fiber assembly may be a commercially available product. Examples of commercially available products thereof include TECHNOWIPE RN100-M (NIPPON PAPER CRECIA CO., LTD.).

The width of the outermost layer is preferably smaller than the width of the substrate layer. That is, it is preferable that the outermost layer be provided on a part of the substrate layer without completely covering the substrate layer. It is preferable that the outermost layer be provided so that the outermost layer is located at the center in the width direction of the substrate layer. In a case where the film includes the pressure-sensitive adhesive layer, which will be described later, between the outermost layer and the substrate layer, the width of the outermost layer is preferably smaller than the width of the pressure-sensitive adhesive layer. That is, it is preferable that the outermost layer be provided on a part of the pressure-sensitive adhesive layer without completely covering the pressure-sensitive adhesive layer. It is preferable that the outermost layer be provided so that the outermost layer is located at the center in the width direction of the pressure-sensitive adhesive layer.

The outermost layer may further contain other components. Examples of those other components include a polymer other than the water-absorbent polymer, a plasticizer, and a pressure-sensitive adhesive component. Examples of those other components also include a component derived from a composition containing the water-absorbent polymer that will be described later.

The outermost layer preferably contains a plasticizer. The plasticizer improves the workability of the film.

Examples of the plasticizer include a polyester-based plasticizer, a polyether ester-based plasticizer, a polyvalent carboxylic acid ester-based plasticizer, a glycerin-based plasticizer, a phosphoric acid ester-based plasticizer, an epoxy-based plasticizer, and a polyacrylic acid ester-based plasticizer.

Examples of the polyester-based plasticizer include a polyester obtained by reacting an acid component (for example, adipic acid, sebacic acid, terephthalic acid, isophthalic acid, naphthalenedicarboxylic acid, or diphenyldicarboxylic acid) with a diol component (for example, propylene glycol and 1,3-butanediol, 1,4-butanediol, 1,6-hexanediol, ethylene glycol, or diethylene glycol). Examples of the polyester-based plasticizer include a polyester consisting of a hydroxycarboxylic acid (for example, polycaprolactone). The terminal of the polyester may be sealed with a monofunctional carboxylic acid or a monofunctional alcohol. The terminal of the polyester may be sealed with an epoxy compound. Examples of commercially available products thereof include ADEKACISER PN-150, PN-170, P-200, and PN-350 manufactured by ADEKA CORPORATION.

The polyether ester-based plasticizer is preferably an organic acid ester of polyalkylene glycol. Examples of the polyalkylene glycol include polyethylene glycol, polypropylene glycol, polybutylene glycol, a poly(ethylene oxide.propylene oxide) block copolymer, a poly(ethylene oxide.propylene oxide) random copolymer, and polytetramethylene glycol. Aromatic units such as bisphenols may be contained in the polyether chain. Examples of the organic acid include a monocarboxylic acid (for example, butanoic acid, isobutanoic acid, 2-ethylbutyric acid, 2-ethylhexanoic acid, and decanoic acid). Examples of commercially available products thereof include ADEKACIZER RS-1000, RS-735, and RS-700 manufactured by ADEKA CORPORATION.

Examples of the polyvalent carboxylic acid ester-based plasticizer include an aliphatic dicarboxylic acid ester, an aromatic dicarboxylic acid ester, a trimellitic acid ester, and a citric acid ester (for example, acetyl triethyl citrate and acetyl tributyl citrate).

Examples of the aliphatic dicarboxylic acid ester include an adipic acid ester (for example, diisodecyl adipate, di-n-octyl-adipate, and di-n-decyl adipate), an azelaic acid ester (for example, di-2-ethylhexyl azelate), and a sebacic acid ester (for example, dibutyl sebacate and di-2-ethylhexyl sebacate).

Examples of the aromatic dicarboxylic acid ester include a phthalic acid ester (for example, dimethyl phthalate, diethyl phthalate, dibutyl phthalate, dioctyl phthalate, diheptyl phthalate, dibenzyl phthalate, and butyl phthalate).

Examples of the trimellitic acid ester include trimethyl trimellitate, triethyl trimellitate, tripropyl trimellitate, tributyl trimellitate, triamyl trimellitate, trihexyl trimellitate, triheptyl trimellitate, tri-n-octyl trimellitate, tri-2-ethylhexyl trimellitate, trinonyl trimellitate, triisononyl trimellitate, tris(decyl) trimellitate, tris(dodecyl) trimellitate, tri(tetradecyl) trimellitate, tris-(C8 to C12 mixed alkyl) trimellitate, tris-(C7 to C9 mixed alkyl) trimellitate, and trilauryl trimellitate. Examples of commercially available products thereof include ADEKACIZER C-8, C-880, C-79, C810, C-9N, and C-10 from ADEKA CORPORATION.

The polyvalent carboxylic acid ester-based plasticizer preferably contains an ether bond. Here, from the viewpoint of flexibility and heat resistance, a polyvalent carboxylic acid ester-based plasticizer that does not contain a polyalkylene oxide structure is preferable. Examples of commercially available products thereof ADEKACIZER RS-107 (dibutoxyethoxyethyl adipate) manufactured by ADEKA CORPORATION. The above compounds are called adipic acid ether ester-based compound.

Examples of the glycerin-based plasticizer include glycerin monoaceto monolaurate, glycerin diaceto monolaurate, glycerin monoaceto monostearate, glycerin diaceto monooleate, and glycerin monoaceto monomontanate.

Examples of the phosphoric acid ester-based plasticizer include tributyl phosphate, tri-2-ethylhexyl phosphate, trioctyl phosphate, triphenyl phosphate, diphenyl-2-ethylhexyl phosphate, and tricresyl phosphate.

Examples of the epoxy-based plasticizer include epoxy triglyceride consisting of an alkyl epoxy stearate and soybean oil. Examples of the epoxy-based plasticizer also include an epoxy resin that contains bisphenol A and epichlorohydrin as raw materials.

Examples of the polyacrylic acid ester-based plasticizer include a polymer of an acrylic acid alkyl ester. The polyacrylic acid ester-based plasticizer may have functional groups such as an epoxy group and a carboxy group. Examples of commercially available products thereof include ARUFON series manufactured by TOAGOSEI CO., LTD. (for example, non-functional UP series).

Examples of other plasticizers include benzoic acid esters of aliphatic polyols such as neopentyl glycol dibenzoate, diethylene glycol dibenzoate, and triethylene glycol di-2-ethylbutyrate, fatty acid amides such as stearic acid amide, aliphatic carboxylic acid esters such as butyl oleate, oxyacid esters such as methyl acetyl ricinolate and butyl acetyl ricinolate, pentaerythritol, sorbitol, a polyacrylic acid ester, silicone oil, and paraffins.

From the viewpoint of heat resistance and effect of the plasticizer, the molecular weight of the plasticizer is preferably 400 to 10,000, and more preferably 500 to 2,000. In a case where the plasticizer has a molecular weight distribution, it is preferable that the weight-average molecular weight of the plasticizer be within the above range.

The outermost layer may contain one kind of plasticizer or two or more kinds of plasticizers.

The content of the plasticizer with respect to 100 parts by mass of the water-absorbent polymer is preferably 1 part by mass to 100 parts by mass, more preferably 5 parts by mass to 70 parts by mass, and even more preferably 10 parts by mass to 50 parts by mass.

The ratio of the total mass of the plasticizer to the total mass of the outermost layer is preferably 1% by mass to 35% by mass, and more preferably 3% by mass to 30% by mass.

From the viewpoint of improving durability, the outermost layer preferably contains a pressure-sensitive adhesive component. The pressure-sensitive adhesive component can make the outermost layer function as a pressure-sensitive adhesive. In a case where the outermost layer functions as a pressure-sensitive adhesive, the film is unlikely to be peel off from an object while being used, and the water stopping properties last for a long time.

Examples of the pressure-sensitive adhesive component include a pressure-sensitive adhesive component contained in the pressure-sensitive adhesive layer which will be described later. The pressure-sensitive adhesive component contained in the outermost layer is preferably polyvinyl alcohol.

The outermost layer may contain one kind of pressure-sensitive adhesive component or two or more kinds of pressure-sensitive adhesive components.

The ratio of the total mass of the pressure-sensitive adhesive component to the total mass of the outermost layer is preferably 1% by mass to 20% by mass.

The thickness of the outermost layer is, for example, 50 μm to 500

The manufacturing method of the outermost layer is not limited. The outermost layer is formed, for example, by applying the water-absorbent polymer onto the fiber assembly. The water-absorbent polymer applied onto the fiber assembly may be dried as necessary. The water-absorbent polymer applied onto the fiber assembly may be heated as necessary. The heating treatment can improve the uniformity of distribution of the water-absorbent polymer in the out-of-plane direction of the outermost layer. Furthermore, the heating treatment can facilitate the coating of the fibers of the fiber assembly with the water-absorbent polymer. The heating temperature is preferably 50° C. to 200° C., and more preferably 100° C. to 180° C.

In the manufacturing method of the outermost layer, a composition containing the water-absorbent polymer may be used. The composition containing the water-absorbent polymer may contain other components such as a plasticizer, a pressure-sensitive adhesive component, a solvent, an ultraviolet absorber, an antioxidant, a crosslinking agent, a surfactant, a filler, a colorant, a light stabilizer, a thickener, and a polymerization initiator.

Substrate Layer

In an embodiment of the present disclosure, the film includes a substrate layer.

Examples of the components of the substrate layer include a resin and a metal. The substrate layer is preferably a substrate layer containing a resin, that is, a resin substrate layer. Examples of the resin include polyolefin, polyester, polyethylene terephthalate (PET), polyethylene naphthalate (PEN), an acrylic resin, polycarbonate (PC), triacetyl cellulose (TAC), a cycloolefin polymer (COP), and an acrylonitrile/butadiene/styrene copolymer resin (ABS resin). From the viewpoint of waterproofness, the substrate layer preferably contains polyethylene, polypropylene, or polyester. The substrate layer may contain one kind of resin or two or more kinds of resins.

It is preferable that the substrate layer have a waterproof function. In a case where the substrate layer has a waterproof function, the film held in a predetermined place improves durability against flooding. In the present disclosure, “waterproof function” means that the leakage amount of water leaking through the substrate layer per hour is 500 g or less in a leak test by filling water at a diameter of 10 mm. The water leakage amount is measured by the following method. First, the substrate layer is collected from the film. A cylindrical tube with a diameter of 10 mm is filled with water to a depth of 100 mm. The substrate layer is attached to the opening of the cylindrical tube, and a lid is put thereon. The cylindrical tube is turned upside down and kept as it is for 1 hour. The amount of water leaking for 1 hour (unit: g) is measured.

The thickness of the substrate layer is, for example, 15 μm to 200 μm.

The substrate layer is preferably an elongated layer. However, the length and width of the substrate layer are not limited. “Length of the substrate layer” means the length of the substrate layer in the longitudinal direction, “width of the substrate layer” means the length of the substrate layer in a direction that is orthogonal to the longitudinal direction and thickness direction of the substrate layer.

Pressure-Sensitive Adhesive Layer

In an embodiment of the present disclosure, the film preferably includes a pressure-sensitive adhesive layer. The pressure-sensitive adhesive layer is preferably disposed between the outermost layer and the substrate layer.

The pressure-sensitive adhesive layer is a layer that functions as a pressure-sensitive adhesive. In the present disclosure, “pressure-sensitive” means that the layer can be stuck to a member (for example, glass) and can be peeled off from the member (for example, glass).

The pressure-sensitive adhesive layer preferably contains a pressure-sensitive adhesive component. Examples of the pressure-sensitive adhesive component include a silicone resin, an acrylic resin, a vinyl resin, polyurethane, a polyamide, a polyester, a polyolefin, and rubber.

Examples of the silicone resin include an addition reaction-type silicone resin, a peroxide curing-type silicone resin, and condensation-type silicone resin.

Examples of the acrylic resin include a homopolymer of an acrylic acid ester compound and a copolymer of an acrylic acid ester compound and other monomers. Examples of the acrylic acid ester compound include methyl (meth)acrylate, ethyl (meth)acrylate, butyl (meth)acrylate, 2-ethylhexyl (meth)acrylate, hydroxyethyl methacrylate, hydroxypropyl methacrylate, dimethylaminoethyl methacrylate, and glycidyl methacrylate. Examples of the aforementioned other monomers include vinyl acetate, (meth)acrylonitrile, (meth)acrylamide, styrene, a methacrylic acid, an acrylic acid, itaconic acid, methylolacrylamide, and maleic acid anhydride.

Examples of the vinyl resin include polyvinyl alcohol and polyvinylpyrrolidone.

Examples of the polyurethane include polyester polyurethane and polycarbonate polyurethane.

Examples of the polyamide include a polyamide obtained by ring-opening polycondensation of undecane lactam (amide 11) and a polyamide obtained by ring-opening polycondensation of lauryl lactam (amide 12).

Examples of the polyester include a polycondensate of a polyvalent carboxylic acid and a polyhydric alcohol. Specifically, examples thereof include polyethylene terephthalate and polybutylene terephthalate.

Examples of the polyolefin include a homopolymer of an olefin and a copolymer of an olefin and other monomers. The olefin is preferably an olefin having 2 to 6 carbon atoms. Examples of the olefin include ethylene, propylene, butene, methylpentene, and hexene. Examples of the copolymer of an olefin and other monomers include an ethylene-vinyl acetate copolymer (EVA), an ethylene-acrylic acid copolyme r (EAA), an ethylene-ethyl acrylate copolymer (EEA), and an ethylene-methyl methacrylate copolymer (EMMA).

Examples of the rubber include a styrene/butadiene copolymer (SBR, SBS), a styrene/isoprene copolymer (SIS), an acrylonitrile-butadiene copolymer (NBR), a chloroprene polymer, and an isobutylene/isoprene copolymer (butyl rubber).

The pressure-sensitive adhesive layer may contain one kind of pressure-sensitive adhesive component or two or more kinds of pressure-sensitive adhesive components.

The thickness of the pressure-sensitive adhesive layer is, for example, 10 μm to 500 μm.

The pressure-sensitive adhesive layer is formed, for example, by applying a composition for a pressure-sensitive adhesive layer containing a pressure-sensitive adhesive component on the substrate layer and drying the composition. The composition for a pressure-sensitive adhesive layer may contain other components. Examples of those other components include a solvent, an ultraviolet absorber, an antioxidant, a crosslinking agent, a surfactant, a filler, a colorant, a light stabilizer, a thickener, and a polymerization initiator.

The pressure-sensitive adhesive layer may be a pressure-sensitive adhesive material obtained by peeling off a peelable liner of a double-sided pressure-sensitive adhesive sheet or a double-sided pressure-sensitive adhesive tape. By attaching the pressure-sensitive adhesive material, which is obtained by peeling off a peelable liner of a double-sided pressure-sensitive adhesive sheet or a double-sided pressure-sensitive adhesive tape, onto the substrate, it is possible to form the pressure-sensitive adhesive layer. The double-sided pressure-sensitive adhesive sheet and the double-sided pressure-sensitive adhesive tape may be commercially available products.

The laminate including the substrate layer and the pressure-sensitive adhesive layer may be a commercially available single-sided pressure-sensitive adhesive sheet or single-sided pressure-sensitive adhesive tape.

Structure

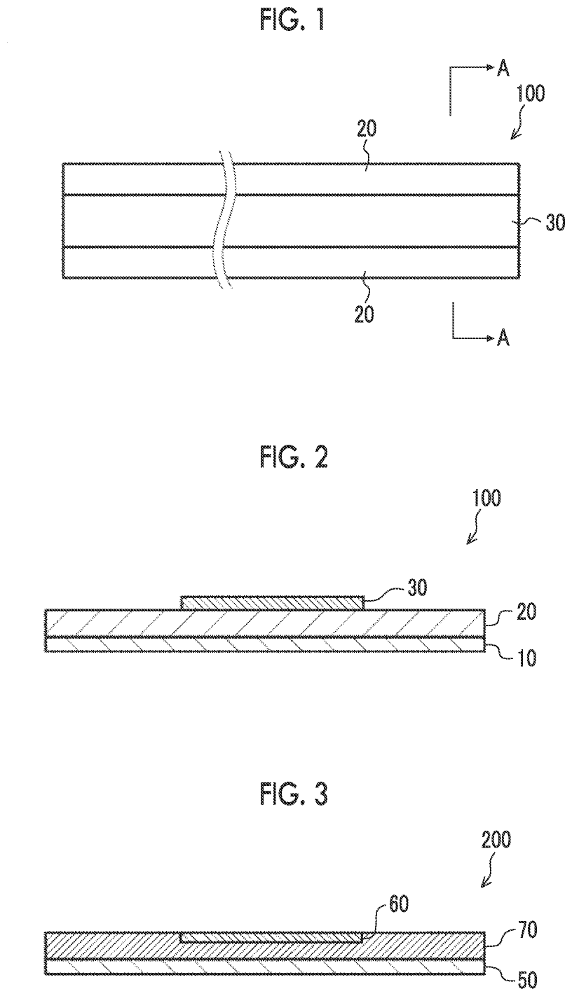

The structure of the film will be described with reference to FIGS. 1 to 3. However, the structure of the film is not limited to the structures shown in FIGS. 1 to 3.

First, FIGS. 1 and 2 will be described. FIG. 1 is a schematic plan view showing the configuration of a film according to an embodiment. FIG. 2 is a cross-sectional view taken along the line A-A in FIG. 1. A film 100 shown in FIGS. 1 and 2 includes a substrate layer 10, a pressure-sensitive adhesive layer 20, and an outermost layer 30 containing a water-absorbent polymer and a fiber assembly in this order.

The length of the pressure-sensitive adhesive layer 20 is approximately the same as the length of the substrate layer 10. The width of the pressure-sensitive adhesive layer 20 is approximately the same as the width of the substrate layer 10. The pressure-sensitive adhesive layer 20 completely covers the substrate layer 10.

The width of the outermost layer 30 is smaller than the width of the substrate layer 10 and the width of the pressure-sensitive adhesive layer 20. A part of the surface of the pressure-sensitive adhesive layer 20 facing the outermost layer 30 is exposed. For example, by disposing the outermost layer 30 so that the outermost layer 30 faces a water permeating hole, and pressing the exposed surface of the pressure-sensitive adhesive layer 20 on a member in the vicinity of a gap, it is possible to fix the film 100.

As shown in FIG. 2, in a cross-sectional view of the film 100, the outermost layer 30 is in the form of a projection protruding in a direction away from the substrate layer 10. Therefore, swelling of the outermost layer 30 makes it possible to more rapidly close the gap and to stop water in a short time. Furthermore, because the outermost layer 30 forms a projection, it is easy to dispose the film 100 at a position where the outermost layer 30 faces the water permeating hole.

As described above, in the film 100 shown in FIGS. 1 and 2, the pressure-sensitive adhesive layer 20 is provided on the substrate layer 10. However, not the pressure-sensitive adhesive layer 20 but the outermost layer 30 may be provided on the substrate layer 10. In a case where the outermost layer 30 is provided on the substrate layer 10, for example, using a pressure-sensitive adhesive tape makes it possible to fix the film to a place where water needs to be stopped.

Next, FIG. 3 will be described. FIG. 3 is a schematic cross-sectional view showing the configuration of a film according to another embodiment. A film 200 shown in FIG. 3 includes a substrate layer 50, an outermost layer 60 containing a water-absorbent polymer and a fiber assembly, and a pressure-sensitive adhesive layer 70. Specifically, the film 200 includes the outermost layer 60 that is on a part of the substrate layer 50, and the pressure-sensitive adhesive layer 70 on a part of the substrate layer 50 that is not covered with the outermost layer 60.

Within one main surface of the film 200, the surface of the outermost layer 60 is flush with the surface of the pressure-sensitive adhesive layer 70. Therefore, it is easy to store the film 200 by rolling up the film.

Examples of the manufacturing method of the film 200 include a first manufacturing method and a second manufacturing method described below.

In the first manufacturing method, first, on a substrate layer, a first pressure-sensitive adhesive layer having the same width as the substrate layer is formed to overlap the substrate layer. An outermost layer having a width smaller than the width of the first pressure-sensitive adhesive layer is attached to the center of the first pressure-sensitive adhesive layer. On a surface of the first pressure-sensitive adhesive layer, the surface not being provided with the outermost layer, a second pressure-sensitive adhesive layer is formed. The second pressure-sensitive adhesive layer can be formed by applying a composition for a pressure-sensitive adhesive layer for forming the second pressure-sensitive adhesive layer in a patterned manner. Examples of the application method include a screen printing method and stripe coating. The height of the second pressure-sensitive adhesive layer is adjusted so that the surface of the second pressure-sensitive adhesive layer is flush with the surface of the outermost layer. Each of the first pressure-sensitive adhesive layer and the second pressure-sensitive adhesive layer may be a pressure-sensitive adhesive material obtained by peeling off a peelable liner of a commercially available double-sided pressure-sensitive adhesive sheet or double-sided pressure-sensitive adhesive tape.

In the second manufacturing method, first, a laminate including a first pressure-sensitive adhesive layer having a width smaller than the width of a substrate layer and an outermost layer are laminated in this order, thereby preparing a laminate. The laminate is attached to the center of a substrate layer so that the first pressure-sensitive adhesive layer is in contact with the substrate layer. On a surface of the substrate layer, the surface not being provided with the laminate, a second pressure-sensitive adhesive layer is formed. The second pressure-sensitive adhesive layer can be formed by applying a composition for a pressure-sensitive adhesive layer for forming the second pressure-sensitive adhesive layer in a patterned manner. Examples of the application method include a screen printing method and stripe coating. The height of the second pressure-sensitive adhesive layer is adjusted so that the surface of the second pressure-sensitive adhesive layer is flush with the surface of the outermost layer. Each of the first pressure-sensitive adhesive layer and the second pressure-sensitive adhesive layer may be a pressure-sensitive adhesive material obtained by peeling off a peelable liner of a commercially available double-sided pressure-sensitive adhesive sheet or double-sided pressure-sensitive adhesive tape.

Use

The film may be used, for example, in a water stopping method using a film. In the water stopping method, the film may be used to prevent or reduce water leakage. In the water stopping method, the film may be used to prevent or reduce flooding. The water stopping method preferably includes preparing the film and disposing the film on an object so that the outermost layer of the film and the object face each other. Disposing the film on an object preferably includes attaching the film to the object. The object may be a building. The object may be a window or a door. For example, in a case where the film is disposed on gaps in objects such as a window and a door, even though water reaches the film, the outermost layer expanding by absorbing water can close the gaps and stop water from entering. The film may be used as a water stopping tape.

Water Stopping Tape

Hereinafter, a water stopping tape according to an aspect of the present disclosure will be described.

In an embodiment of the present disclosure, the water stopping tape includes the film described above. Aspects of the film in the water stopping tape are described in the aforementioned section of “Film”. The preferable aspect of the film in the water stopping tape is the same as the preferable aspect of the film described in the aforementioned section of “Film”. The film in the water stopping tape preferably includes a pressure-sensitive adhesive layer.

The form of the water stopping tape is not limited. The water stopping tape may be a water stopping tape wound in a cylindrical shape. The water stopping tape may be a flat plate-shaped water stopping tape. The water stopping tape may be a long water stopping tape. The water stopping tape may be a water stopping tape in the form of polygon such as a quadrangle.

The water stopping tape is used, for example, in various water stopping methods. The water stopping tape is preferably used in the water stopping method described above.

### EXAMPLES

Hereinafter, the present disclosure will be specifically described with reference to examples. However, the present disclosure is not limited to the following examples. What are described in the following examples may be modified as appropriate as long as the modification is within the gist of the present disclosure.

### Example 1

A nonwoven fabric (trade name: TECHNOWIPE RN100-M, NIPPON PAPER CRECIA CO., LTD.) was cut in dimensions of 100 mm×100 mm. A polyurethane (trade name: AQUACALK TWB, SUMITOMO SEIKA CHEMICALS CO., LTD., 2.0 g) was uniformly sprayed on a nonwoven fabric, and then a heating treatment using a hot press machine (MINI TEST PRESS MP-WCL, Toyo Seiki Seisaku-sho, Ltd.) was performed on the nonwoven fabric for 1 minute at 150° C. so that the polyurethane permeated the nonwoven fabric. The central portion of the nonwoven fabric was cut into a rectangle having dimensions of 50 mm×100 mm. A pressure-sensitive adhesive tape (trade name: FIT LIGHT TAPE strong pressure-sensitive adhesive No. 736 Mango, width: 100 mm, SEKISUI CHEMICAL CO., LTD.) was cut in a length of 100 mm. The pressure-sensitive adhesive tape includes a substrate layer containing polyester and a pressure-sensitive adhesive layer. The nonwoven fabric was attached to the central portion of the pressure-sensitive adhesive tape having dimensions of 100 mm×100 mm. By the above procedure, a film including an outermost layer, a pressure-sensitive adhesive layer, and a substrate layer in this order was prepared. The outermost layer contains a polyurethane and a nonwoven fabric.

In addition, a film for measuring a degree of expansion that will be described later was prepared by the manufacturing method described above, except that “polygon having dimensions of 50 mm×100 mm” was replaced with “circle having a diameter of 100 mm”.

### Example 2

A film was prepared according to the method described in Example 1, except that the polyurethane (trade name: AQUACALK TWB, SUMITOMO SEIKA CHEMICALS CO., LTD.) used in Example 1 was changed to a mixture of a polyurethane (2.0 g, trade name: AQUACALK TWB-P, SUMITOMO SEIKA CHEMICALS CO., LTD.) and a plasticizer (0.4 g, trade name: ADEKACIZER RS-1000, ADEKA CORPORATION).

### Example 3

A film was prepared according to the method described in Example 1, except that the temperature in the heating treatment was changed to 80° C.

### Example 4

Polyethylene oxide (100 g, 2.0 mmol) having a weight-average molecular weight of 50,000, polypropylene oxide (19.8 g, 5.0 mmol) having a weight-average molecular weight of 4,000, 1,4-butanediol (0.75 g, 8.3 mmol), 4,4′-diphenylmethane diisocyanate (3.62 g, 14.5 mmol), and methyl ethyl ketone (150.0 g) were mixed together at room temperature. The obtained mixture was heated to 50° C., and NEOSTANN U-600 (0.02 g) was added to the mixture. The mixture was stirred for 10 minutes, then heated to 60° C., and stirred for 6 hours. The obtained reaction solution was added to methanol, thereby obtaining a polyurethane (1).

A film was prepared according to the method described in Example 2, except that the polyurethane (trade name: AQUACALK TWB-P) used in Example 2 was changed to the polyurethane (1).

### Comparative Example 1

A film was prepared according to the method described in Example 1, except that a polyurethane film was manufactured by the heating treatment described in Example 1 without using a nonwoven fabric, and the polyurethane film was attached to a pressure-sensitive adhesive tape.

### Comparative Example 2

A film was prepared according to the method described in Example 1, except that a polyurethane was not used, and a heating treatment was not performed.

### Comparative Example 3

A film was prepared according to the method described in Example 1, except that the polyurethane (trade name: AQUACALK TWB, SUMITOMO SEIKA CHEMICALS CO., LTD.) used in Example 1 was changed to a (meth)acrylate-based polymer (2 g, trade name: SUNFRESH ST-250, SANYO CHEMICAL, LTD.), and a heating treatment was not performed.

Water Absorbency

A sample (0.1 g) was added to 200 mL of pure water, and the mixture was stirred. After 3 hours of stirring, the mixture was filtered through a wire mesh (product name: TESTING SIEVE, wire diameter: 50 μm, diameter: 150 mmφ, TOKYO SCREEN CO., LTD) having an opening size of 75 μm. The mass of the sample remaining on the wire mesh was measured. The measured mass (unit: g) was divided by 0.1 g, and the obtained value was adopted as water absorbency.

Degree of In-Plane Swelling (X) and Degree of Out-of-Plane Swelling (Z)

The outermost layer was peeled off from each film and then immersed in pure water at 25 C. For the film prepared without using a nonwoven fabric, the outermost layer peeled off from the film was cut into a circle having a diameter of 100 mm and then immersed in pure water at 25° C. After being immersed for 5 hours, the outermost layer was taken out of the pure water. The ratio of the maximum diameter of the outermost layer having been immersed to the maximum diameter of the outermost layer not yet being immersed was calculated, and the obtained value was adopted as “degree of in-plane swelling (X)”. Furthermore, the ratio of the maximum thickness of the outermost layer having been immersed to the maximum thickness of the outermost layer not yet being immersed was calculated, and the obtained value was adopted as “degree of out-of-plane swelling (Z)”. The thickness of the outermost layer was measured using a stylus-type film thickness meter. Specifically, the outermost layer was placed on a stainless steel plate (thickness: 200 μm), and then the thickness of the laminate including the stainless steel plate and the outermost layer was measured using a stylus-type film thickness meter. The thickness of the stainless steel plate was sub stracted from the thickness of the laminate including the stainless steel plate and the outermost layer, thereby determining the thickness of the outermost layer.

Distribution of Water-Absorbent Polymer

The cross section of the outermost layer was visually observed, and the distribution of water-absorbent polymer was evaluated according to the following standard. Table 1 shows the evaluation results.

A: The water-absorbent polymer is uniformly distributed in the fiber assembly along the out-of-plane direction of the outermost layer.

B: The water-absorbent polymer is not uniformly distributed in the fiber assembly along the out-of-plane direction of the outermost layer.

Coating Properties of Water-Absorbent Polymer

By visual observation and microscopic observation of the cut surface, the coating properties of the water-absorbent polymer were evaluated according to the following standard. Table 1 shows the evaluation results.

A: The water-absorbent polymer coats the fibers of the fiber assembly.

B: The water-absorbent polymer does not coat the fibers of the fiber assembly.

Evaluation: Time Required for Stopping Water

As an experimental water tank, an acryl water tank was prepared which has a hole having a width of 50 mm and a height of 10 mm at the lower portion of the wall surface. The water tank has a width of 300 mm, a depth of 300 mm, and a height of 700 mm. The film was attached to the inner wall surface of the experimental water tank so that the outermost layer of the film faced the hole. Water was poured into the experimental water tank to a height of 500 mm. The time it took to stop water leaking from the hole from when pouring of water into the experimental water tank had finished (that is, the time required for stopping water) was measured. Here, in a case where the water leakage is not stopped, the failure of water stoppage is marked as “N. D.”. Table 1 shows the evaluation results.

Evaluation: Duration of Water Stoppage

In the water stopping test described in the section of “Evaluation: time required for stopping water” described above, the time it took to stop water leaking again from the hole from when pouring of water into the experimental water tank had finished (that is, duration of water stoppage) was measured. The duration of water stoppage was evaluated according to the following standard. Here, in a case where the water leakage is not stopped, the failure of water stoppage is marked as “N. D.”. Table 1 shows the evaluation results.

A: The duration of water stoppage exceeds 36 hours.

B: The duration of water stoppage exceeds 24 hours and is equal to or less than 36 hours.

C: The duration of water stoppage is 24 hours or less.

Evaluation: Durability

In the water stopping test described in the above section “Evaluation: Time required for stopping water”, the film was taken out 36 hours after when pouring of water into the experimental water tank had finished, and the film was visually checked. According to the following standard, the durability was evaluated. Table 1 shows the evaluation results.

A: The outermost layer is not dissolved and is not peeled off.

B: A part of the outermost layer is dissolved or peeled off.

C: The outermost layer is dissolved or peeled off.

Evaluation: Workability on Curved Surface

The film was attached to the inner bottom surface and the inner wall surface of the water tank described in the section of “Evaluation: time required for stopping water” described above, and the way the water tank and the film come into contact with each other at the corner of the water tank (that is, the portion where the bottom surface and the wall surface cross each other) was visually checked. The angle between the inner bottom surface and the inner wall surface of the water tank is 90° . According to the following standard, the workability on a curved surface was evaluated. The evaluation results are shown in Tables 1 and 2.

A: No gap occurs between the water tank and the film at the corner of the water tank.

B: A gap occurs between the water tank and the film at the corner of the water tank.

TABLE 1

| | | | | | | | Comparative | Comparative | Comparative |
|---|---|---|---|---|---|---|---|---|---|
| | | | Example 1 | Example 2 | Example 3 | Example 4 | Example 1 | Example 2 | Example 3 |
| Outermost | Water- | Type | AQUACALK | AQUACALK | AQUACALK | Polyurethane | AQUACALK | — | SUNFRESH |
| Layla | absorbent | | TWB | TWB-P | TWB | (1) | TWB | | ST-250 |
| | polymer | Water | 25 | 25 | 25 | 14 | 25 | — | 700 |
| | | absorbency | | | | | | | |
| | | (g/g) | | | | | | | |

| | Plasticizer | — | ADEKACIZER | — | ADEKACIZER | — | — | — |
|---|---|---|---|---|---|---|---|---|
| | | | RS-1000 | | RS-1000 | | | |
| | Fiber assembly | TECHNOWIPE | TECHNOWIPE | TECHNOWIPE | TECHNOWIPE | — | TECHNOWIPE | TECHNOWIPE |
| | | RN100-M | RN100-M | RN100-M | RN100-M | | RN100-M | RN100-M |
| Substrate layer and pressure- | | FITLIGHT | FITLIGHT | FITLIGHT | FITLIGHT | FITLIGHT | FITLIGHT | FITLIGHT |
| sensitive adhesive layer | | TAPE | TAPE | TAPE | TAPE | TAPE | TAPE | TAPE |
| | | No. 736 | No. 736 | No. 736 | No. 736 | No. 736 | No. 736 | No. 736 |
| Temperature of heating | | 150 | 150 | 80 | 150 | 150 | — | — |
| treatment (° C.) | | | | | | | | |
| Degree of in-plane swelling | | 1.0 | 1.0 | 1.0 | 1.0 | 2.7 | 1.0 | 1.0 |
| of outermost layer (X) | | | | | | | | |
| Degree of out-of-plane swelling | | 14.3 | 13.1 | 7.9 | 7.0 | 2.7 | 1.0 | 1.0 |
| of outermost layer (Z) | | | | | | | | |
| (Z)/(X) | | 14.3 | 13.1 | 7.9 | 7.0 | 1.0 | 1.0 | 1.0 |
| Distribution of water- | | A | A | B | A | — | — | B |
| absorbent polymer | | | | | | | | |
| Coating properties of water- | | A | A | A | A | — | — | B |
| absorbent polymer | | | | | | | | |
| Evaluation | Time required for | 15 | 15 | 10 | 20 | N.D. | N.D. | N.D. |
| | stopping water (min) | | | | | | | |
| | Duration of | A | A | A | A | N.D. | N.D. | N.D. |
| | water stoppage | | | | | | | |
| | Durability | A | A | B | A | N.D. | N.D. | N.D. |
| | Workability on | B | A | B | A | A | A | A |
| | curved surface | | | | | | | |

Table 1 shows that the duration of water stoppage is better in Examples 1 to 4 than in Comparative Examples 1 to 3.

### EXPLANATION OF REFERENCES

10, 50: substrate layer

20, 70: pressure-sensitive adhesive layer

30, 60: outermost layer

100, 200: film

What is claimed is:

1. A film comprising, in the following order:
an outermost layer that contains a water-absorbent polymer and a fiber assembly; and
a substrate layer,
wherein a degree of out-of-plane swelling of the outermost layer is higher than a degree of in-plane swelling of the outermost layer.

2. The film according to claim 1,
wherein the degree of in-plane swelling of the outermost layer is isotropic.

3. The film according to claim 1,
wherein the water-absorbent polymer coats fibers of the fiber assembly.

4. The film according to claim 2,
wherein the water-absorbent polymer coats fibers of the fiber assembly.

5. The film according to claim 1,
wherein the outermost layer contains a plasticizer.

6. The film according to claim 2,
wherein the outermost layer contains a plasticizer.

7. The film according to claim 3,
wherein the outermost layer contains a plasticizer.

8. The film according to claim 1,
wherein the water-absorbent polymer includes a polyurethane.

9. The film according to claim 2,
wherein the water-absorbent polymer includes a polyurethane.

10. The film according to claim 3,
wherein the water-absorbent polymer includes a polyurethane.

11. The film according to claim 4,
wherein the water-absorbent polymer includes a polyurethane.

12. The film according to claim 5,
wherein the water-absorbent polymer includes a polyurethane.

13. The film according to claim 6,
wherein the water-absorbent polymer includes a polyurethane.

14. The film according to claim 7,
wherein the water-absorbent polymer includes a polyurethane.

15. A water stopping tape comprising:
the film according to claim 1.

16. A water stopping tape comprising:
the film according to claim 2.

17. A water stopping tape comprising:
the film according to claim 3.

18. A water stopping tape comprising:
the film according to claim 4.

19. A water stopping tape comprising:
the film according to claim 5.

20. A water stopping tape comprising:
the film according to claim 8.
